(19) United States
(12) Patent Application Publication
(10) Pub. No.: US 2025/0133111 A1
(43) Pub. Date: Apr. 24, 2025

(54) Email Security and Prevention of Phishing Attacks Using a Large Language Model (LLM) Engine

(71) Applicant: VARONIS SYSTEMS, INC., New York, NY (US)

(72) Inventors: John Eugene Neystadt, Kfar Saba (IL); Amit Cohen, Kfar Saba (IL); Lior Chen, Tel Mond (IL); Ron Sne, Atlit (IL)

(21) Appl. No.: 18/383,076

(22) Filed: Oct. 24, 2023

(51) Int. Cl. H04L 9/40; H04L 51/212

(52) U.S. Cl. CPC H04L 63/1483; H04L 51/212

(57) ABSTRACT

Improved email security and prevention of phishing attacks using a Large Language Model (LLM) engine. A computerized method includes evaluating whether a digital message received at a Protected Entity is malicious or legitimate, by performing: (a) obtaining extracted data from documents and data repositories of the Protected Entity; feeding the extracted data into an LLM engine; and constructing an Organizational Context Index having vectors of LLM-generated embeddings that describe relations and roles of members and objects of the Protected Entity; (b) prompting the LLM to evaluate whether the digital message is malicious or legitimate, based on LLM analysis of a query envelope that includes at least: (i) content of the digital message, and (ii) meta-data of the digital message, and (iii) a set of LLM-based embeddings from the Organizational Context Index that pertain to that digital message.

### FIELD

Some embodiments are related to the field of computerized systems.

### BACKGROUND

Corporations, organizations, and other entities typically store numerous files and documents that pertain to their business, their products, their assets, their customers, their employees, or the like. Some organizations store millions of such files and documents. Storage may be performed locally on a server or data repository located on-premises, or remotely on a server or data repository located remotely or at a cloud-computing provider.

### SUMMARY

Some embodiments include systems, devices, and methods for improving and enhancing security of computerized systems, and particularly for improving email security and email-related security, as well as detection and prevention of cyber-attacks and/or social engineering attacks or “phishing” attacks.

Some embodiments may similarly be used for automatic detection of incoming communications that are malicious or fraudulent, or that are “spam” or “junk” communications, or that reflect customer anger or customer dissatisfaction, or the like.

Some embodiments may provide other and/or additional benefits and/or advantages.

### BRIEF DESCRIPTION OF THE DRAWINGS

FIG. 1 is a schematic block-diagram illustration of a system, in accordance with some demonstrative embodiments.

### DETAILED DESCRIPTION OF SOME DEMONSTRATIVE EMBODIMENTS

The term “cyber-attack” as used herein may include, for example, a “phishing” attack, a Business Email Compromise (BEC) attack, a social engineering attack, and/or other types of attacks against a computerized system or against an end-user of an electronic device (e.g., laptop computer, desktop computer, smartphone, tablet, smart-watch, or the like); and particularly, an attack in which a fraudulent message is sent by email or via Short Message Service (SMS) text or via Instant Messaging (IM) text (e.g., via WhatsApp, via iMessage, or the like), or via a collaborative messaging or a workspace messaging or a team messaging or a group messaging or a cross-platform messaging system or an organizational/enterprise messaging system (e.g., similar to Slack or Microsoft Teams) or an organizational/enterprise message board or digital communication forum, or via other means (e.g., by posting a fraudulent message as a post on a social media website or network or forum); and particularly, wherein the fraudulent message is sent or is conveyed to a victim recipient, and appears to arrive from (or, to be sent by) a legitimate person and/or an authorized entity, and requests or instructs the victim recipient to perform one or more operations online and/or offline (e.g., to perform an urgent wire transfer or online payment; to perform an online purchase of goods or services; to perform a log-in process into an online website or account, or into a bank account or an electronic commerce account; to provide or to enter or to send-back or to convey a secret data-item such as a password or a PIN or a one-time code or a one-time authentication factor; to click on a link or hyperlink; to download and/or to install and/or to launch and/or to open a particular application or app or code or file; to send or to upload a particular file or data-item; to perform a non-digital operation in the real world, such as to open a physical door or gate to an office or a building; and/or other operations); and including, but not limited to, an attack in which a message is sent or published or conveyed via textual content, graphical content, audio content, video content, audio-and-video content, animation, attached file(s), and/or other types of data or content or a combination thereof.

The terms “message” as used herein may include, for example, any content that is conveyed or sent or delivered or presented to a recipient victim or to a plurality of recipient victims; such as, via email, via SMS text, via IM, via an online post on a website or phishing site or social media network or blog or other online venue; including, but not limited to, textual message or content, graphic elements, audio and/or video elements, animation elements, as well as meta-data of such message (e.g., time and date of sending/receiving/posting; Internet Protocol (IP) address of the sender and/or of relay nodes; size in bytes; or the like).

The Applicant has realized that messages and content are frequently used as means to perform or to attempt fraudulent transactions or malicious activities, and that phishing emails or phishing content (e.g., posted or published online) have become a major source of cyber-attacks against individuals and corporations; typically causing a victim or a recipient to submit or to share log-in credentials with a malicious actor, or persuading a victim or a recipient to perform one or more operations (online and/or offline) that are intended to damage that victim and/or to provide illegitimate gain to the attacker or to a third party. Furthermore, realized the Applicant, phishing emails and phishing posts and contents are sometimes use as an interim tool for obtaining access to privileged resources and/or to launch other types of cyber-attacks or real-world attacks, towards the same victim and/or towards third parties.

The Applicant has further realized that it may be difficult for many human users to correctly distinguish between a phishing email message (or content) and a legitimate message (or content). For example, in a “false negative” error of the victim, he incorrectly identifies an incoming message as a legitimate message, and then innocently performs a wire transfer to a bank account of an attacker. Similarly, in a “false positive” error of the victim, she incorrectly identifies an incoming message as a phishing attempt, and discards the message or refuses to perform the operations requested in the email, thereby possibly causing damage to another individual or to an organization (e.g., the victim fails to perform a requested immediate payment to an Internet Service Provider (ISP) or hosting company, and the website of an organization goes offline for hours).

The Applicant has also realized that such distinguishing between phishing (or attacking) emails and legitimate emails has recently become even more difficult than before; as some cyber-attackers now use generative Artificial Intelligence (AI) engines and chat-bots, such as OpenAI Chat-GPT or Google Bard, to automatically or semi-automatically compose high-quality phishing messages in a target language of the recipient, to improve or fine-tune the content of such phishing messages, and to fine-tune or tailor the content of such phishing messages to a particular victim or to a particular type-of-victims (e.g., CFO's of corporations).

In accordance with some embodiments, an organization or enterprise or corporate entity may be referred to as the “Protected Entity”, and may have one or more computerized systems; for example, an intranet, an organizational communication system, an email system, a data storage system or data repository, local/on-premises repositories and servers, remote or cloud-based or off-premises or distributed repositories and servers, databases, a static or manually-updated directory of users and/or employees and/or team-members and/or contacts of the organization, an Active Directory which stores and dynamically updates information about objects and/or computerized entities and/or various types of users of the corporate network, a Customer Relationship Management (CRM) system or application, a Supply Chain Management (SCM) system or application, an Enterprise Resource Planning (ERP) system or application, and/or other computerized systems.

In accordance with some embodiments, Organizational Context (OC) or Enterprise context (EC) is constructed and updated by or at the Protected Entity, automatically by a computerized agent or unit; on a continuous or generally-continuous basis, or periodically or at pre-defined time intervals (e.g., every hour, every day), and/or in response to pre-defined triggering events or conditions (e.g., automatically upon connection or deployment of a new data repository or database or CRM system or SCM system or ERP system). For example, organizational data sources are scanned and/or indexed and/or searched, to generate enterprise data context or OC that can then be applied with regard to a particular user/sender/recipient/email message/content item; based on the known list and data of employees, contractors, team-members, consultants, business partners, professional advisors (e.g., attorneys, accountants), suppliers and vendors, and customers and clients. The OC data is converted or transformed into embeddings, that are stored in an index.

An email security agent or scans or analyzes incoming emails and/or other messages that are conveyed or sent to end-users or recipients at the Protected Entity (e.g., SMS messages, IM messages, collaborative/team/workspace messaging item, website content, online posts that are accessed); performs tokenization of each such incoming (or conveyed) content or message; and converts the incoming (or conveyed) message or its tokens into indexed embeddings. Optionally, the email security agent then enriches or augments the message (or the conveyed content) with the relevant OC, by looking up email embeddings in the previously-generated OC embeddings index.

The email security agent then looks up for answers to a set of security questions that can be obtained from pre-defined templates or questionnaires, on may otherwise obtain OC-enriched input with regard to parameters or content or meta-data of the scanned email message (or content), such as: (a) is this email message solicited (e.g., appears to be a response of Customer A to a previous email sent to him by Employee B of the organization) or unsolicited; (b) does this email message appears to have been composed by a native speaker of the language in which this email message is written (e.g., the email message is in English, but begins with “Bonjour” and is thus suspicious); (c) did this email message arrive from a sender that is known to the organization (e.g., a known/existing vendor or customer or employee), or from an unknown/never-before-seen sender; (d) does the subject or the topic of the email belong to a type of topics or subjects that are often associated with fraud (e.g., “Urgent Wire Transfer Required”); (e) does the subject or topic of the email appear to match the role of the sender as deduced from the OC (e.g., an email message about marketing has indeed arrived from a team-member of the marketing department; whereas, an email message about an urgent outgoing wire transfer is typically not expected to arrive from a Customer Support team-member of the organization); (f) does the subject or topic of the email appear to match the role of the recipient as deduced from the OC (e.g., an email message about marketing has indeed arrived to a team-member of the marketing department; whereas, an email message about an urgent outgoing wire transfer is typically not expected to arrive to a Customer Support team-member of the organization); and/or answers to other or additional questions. In accordance with some embodiments, the answers to these pre-defined questions may be obtained by an LLM engine that has access to the OC; and/or by utilizing a set of deterministic rules or if-then clauses or conditions (e.g., “if the Subject of the email contains the word Marketing, is the Sender of the email a team-member in the Marketing Department of the organization?”).

It is noted that in some embodiments, the particular questions to be answered are selected from a pool or bank of pre-defined probing questions; for example, randomly or pseudo-randomly, or by using pre-defined question-selection rules or conditions that indicate to the email security agent which questions or groups-of-questions to select. For example, an initial detection that the scanned email message requests the recipient to perform a wire transfer, may trigger the utilization of a first set of pre-defined questions; whereas, an initial detection that the scanned email message requests the recipient to log-in into a particular resource may trigger the utilization of a second, different, set of pre-defined questions. Similarly, the existence or the absence of particular keywords or terms in the scanned message (e.g., “urgent”, or “password”, or “you must pay”) may trigger the utilization of a particular set or subset of questions. In some embodiments, different subsets of pre-defined questions may be aggregated and used in combination, based on different cumulative triggers.

Based the answers to the pre-defined questions, a set of features is generated. The features are fed to a Machine Learning (ML) engine, which may include a non-supervised ML unit and/or a pre-trained/supervised ML unit. The ML unit(s) can be trained by utilizing, for example, (i) a first dataset of email messages (or other content) that are known to be phishing/fraudulent messages; and/or (2) a second dataset of email messages (or other content) that are known to be legitimate/non-attacking/non-phishing messages. The training may include, for example, assigning particular weights or relative weights or absolute weights to each feature or parameter, as well as determining threshold value(s) for declaring a particular email message (or content) as phishing-related (or as more-probably phishing related, or as most-probably phishing related, or as certainly phishing related) or conversely as legitimate/benign/non-attacking/non-phishing; thus enabling the ML unit(s) to identify phishing related email messages (or content), or to identify or recognize or classify a particular email message (or content) as phishing-related or attack-related or malicious or fraudulent.

The email security agent may calculate the confidence score or the certainty score with regard to the legitimacy of a particular scanned email (or content), based on the features that were extracted and evaluated; and a particular email message (or content) that is determined or estimated or evaluated to be phishing-related or attack-related or malicious or fraudulent, may be handled by one or more particular fraud-mitigation/attack-prevention mechanisms; for example, the message may be deleted or discarded, or quarantined, or moved to a “Junk/Spam” folder, or flagged for particular review of a system administrator or a fraud department or of the intended recipient. In some embodiments, different confidence score values may trigger different types of remedial/preventive actions; for example, a higher confidence score may trigger deleting or quarantining of the suspicious message into a quarantined folder or vault (e.g., requiring an administrator to release the message, and/or requiring a set of operations to release or to view the message); whereas a lower confidence score may trigger flagging of the message as “possibly malicious-please read with caution”.

In some embodiments, a feedback loop may be used in order to assist the computerized system to correct errors, and/or fine-tune the models or engines used. For example, the recipient reviewed quarantined/flagged email messages (or other content), and may use feedback buttons/links/response flags to validate the correctness (or the incorrectness) of the evaluation decisions that were reached by the email security agent, and/or to optionally override such decisions. In some embodiments, the recipient may further query the system what were the prevailing/dominant features of the email message that contributed (the most, or at all) to the decision of classifying the email as malicious or as legitimate; and may indicate back to the system, via a feedback mechanism, that a particular feature was actually incorrect, or should have been assigned a lower weight; thereby contributing to improvement of the decision-making process for subsequent emails that the system scans and classifies.

For demonstrative purposes, some portions of the discussion may relate to classification of incoming messages (or communications) as phishing-related or non-phishing-related, or to their classification as either fraudulent/malicious/attack-related or conversely as legitimate/benign/non-malicious/non-fraudulent, based on utilization of OC. However, some embodiments may similarly be utilized for other purposes; for example: to detect “spam” or “junk” emails or messages or content; to detect whether or not an incoming message is an unsolicited advertising message; to detect whether or not an incoming message reflects a communication from an angry/disappointed customer, or from a customer who is about to switch to another provider or supplier; to classify the level of anger or disappointment that is conveyed in the incoming communication; to monitor or to improve the performance of customer support team-members; to perform other classification/evaluation decisions with regard to the content and/or the tone of incoming messages; and/or to otherwise facilitate rapid automation of handling incoming message and/or accurate routing of such incoming messages to the more appropriate team-member (e.g., routing an incoming email to the regular Customer Support team or conversely to the Customer Retention team if the message conveys anger and disappointment) and/or efficient escalation of particular messages to a higher level in the organizational hierarchy.

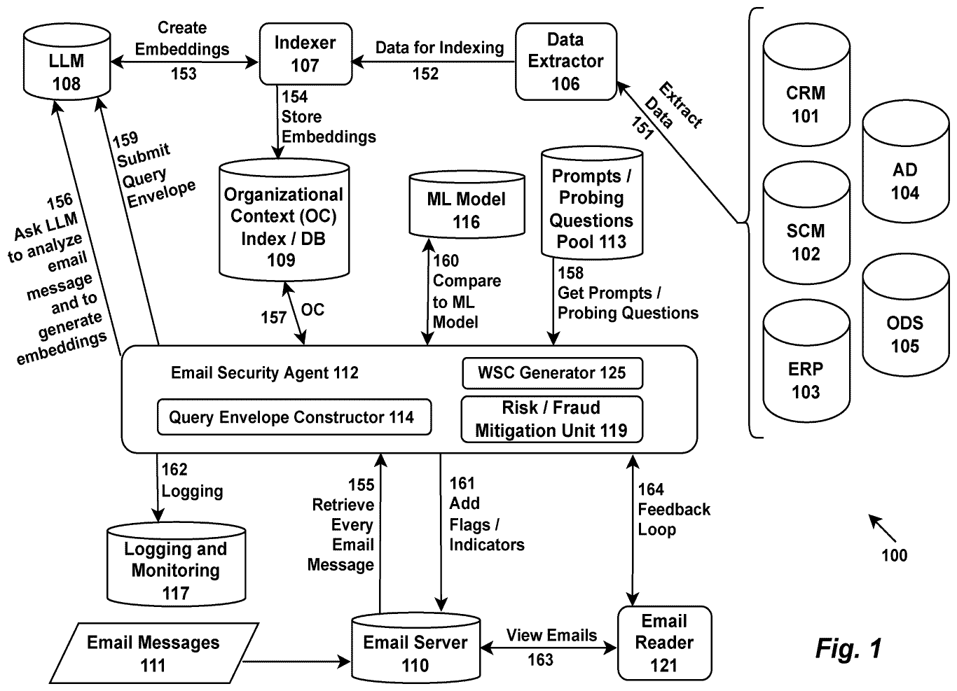

Reference is made to FIG. 1, which is a schematic block-diagram illustration of a system 100, in accordance with some demonstrative embodiments.

For example, a Protected Entity (e.g., an organization, an enterprise, a corporation) may have one or more data repositories or database or computerized sub-systems; such as: a CRM unit 101, a SCM unit 102, an ERP unit 103, an Active Directory (AD) management unit 104, and/or other Organizational Data Sources (ODSs) 105 (e.g., financial data; legal data; marketing data; sales data; Human Resources (HR) data). Sources 101-105 are only non-limiting examples; and they may further include other and/or additional types of organizational databases, servers, repositories, or data. For example, sources 101-105 may further include email messages and past email correspondence (including email messages, email meta-data, email content, email attachments, email headers, email relay nodes or relay path data, or the like) obtained from an Email Server of the organization e.g., from Email Server 110 described herein), Instant Messaging (IM) messages or content from an IM server or gateway or sub-system, collaborative/team/group/workspace messaging content from a respective collaborative/team/group/workspace messaging application or sub-system of the organization, a manually-curated or automatically-generated list of organizational contacts, a list or directory of the organization's employees and/or team-members and/or contractors and/or consultants and/or directors and/or other related entities, a list or directory of companies or corporations that are related to the Protected Entity (e.g., subsidiary or parent company) and optionally also lists of team-members of such related company, and/or other data of the organization. Such additional sources of data, as explained herein, may be used for extracting and generating Organizational Context and/or User Context (or user-related context, or user-based context).

A Data Extractor 106 is configured to continuously or periodically extract or pull data (arrow 151) from sources 101-105; and particularly, to extract recently-updated/recently-added data from such sources in order to add such data to already-extracted/previously-extracted data.

The extracted data is sent (arrow 152) to an Indexer Unit 107, which utilizes a Large Language Models (LLM) 108 to generate a vector of floating numbers or embeddings (arrow 153) that are stored (arrow 154) in an Organizational Context Index/Database 109 (e.g., stored as one or more vector databases). For demonstrative purposes, and in order to avoid over-crowding of the drawing, unit 109 is shown as Organizational Context Index/Database 109; however, it may also store, in the same/single database and/or in an associated database or a separate database, User Context or user-based context or user-related context, as described herein, which relates to one or more characteristics of the sender of a message and/or a recipient of a message; and accordingly, the terms “OC” or “Organizational Context”, as used herein, may further include such additional User Context or user-based context or user-related context as described herein.

In some embodiments, the data extraction and the updating of the OC are incremental, such that the that Organizational Context Index/Database 109 is incrementally updated based on newly-extracted organizational data that was extracted from recently-modified/recently-added data objects or data sources. In other embodiments, or additionally or alternatively, the Organizational Context Index/Database 109 may be periodically re-constructed from scratch by re-scanning the entire body-of-knowledge of the data sources 101-105, such as daily or weekly, thereby replacing an older version of the entire Organizational Context Index/Database 709 with a fresh/updated version thereof.

For demonstrative purposes, an Email Server 110 is shown, configured to receive incoming email messages 111 from various recipients; however, this is only a non-limiting example; and some embodiments may similarly utilize a Communications Server, configured to receive/relay/handle other types of messages or content, for example, an SMS gateway, an IM server or gateway, a filtering unit for web content or for social media content, or other network element that can operate as an interim unit or filtering unit with regard to incoming messages/content.

Continuing with the non-limiting example of email messages, an Email Security Agent 112 operates to scan all incoming email messages, retrieving them (arrow 155) from the Email Server 110 or being implemented as part of the Email Server 110 or as an add-on to the Email Server 110 or otherwise being operably associated with the Email Server 110.

The Email Security Agent 112 requests from the LLM 108 (arrow 156) to analyze the email message and to convert the email message, including its content and its meta-data (e.g., header data; recipient name/email address/data; sender name/email address/data; IP address of sender and of relay nodes or relay servers; trace-route data; subject data; information about CC recipients; list of email relays), into embeddings.

The Email Security Agent 112 retrieves or obtains or receives (arrow 157) from the Organizational Context Index/Database 109, the particular OC that matches the particular embeddings that were determined by the LLM 108 for this specific email message as described above.

The Email Security Agent 112 further retrieves a particular set or subset of prompts (arrow 158) or probing questions, from a Prompts Pool 113 storing pre-defined prompts (or, from a pool or bank of probing questions), which indicate or summarize a list of relevant questions that the Email Security Agent 112 will ask the LLM 108 with regard to this specific email message; and the Email Security Agent 112 adds them via prompt injection, together with the relevant portion of extracted OC, to the email message itself. The Email Security Agent 112 thus constructs a query envelope, optionally utilizing Query Envelope Constructor 114 or other packaging sub-unit or module, such that the query envelope includes, or indicates to the LLM 108: (i) the content of the specific email message, and (ii) the meta-data of the specific email message, and (iii) the particular OC that is relevant to this specific email message, and (iv) the relevant prompts or questions that are relevant to this email message, and (v) a prompt or a command to indicate in the LLM-based response the relevant confidence score for each question separately. The constructed query envelope is submitted (arrow 159) from the Email Security Agent 112 to the LLM 108; and the LLM 108 performs LLM-based analysis, utilizing a general body-of-knowledge on which the LLM was generally trained and also based on the particular additional data contained in the query envelope, and sends back a response package to the Email Security Agent 112, indicating the LLM-based answer to each question and also indicate a confidence score or confidence level (e.g., in a range of 0 to 100) for each answer. Each of these answers is utilized as an indicator of a feature for ML-based classification or evaluation.

For example, Email Security Agent 112 obtains or retrieves (arrow 160) a Phishing Detection ML Model 116 (or other suitable ML model; as phishing attack detection is only a non-limiting example of some embodiments), that indicates weights or relative weights that are assigned to each feature. Based on the LLM-based answers and the obtained weights, the Email Security Agent 112 determines or calculates a weighted phishing confidence score; which in turn is provided to one or more units or recipients; for example, the weighted phishing confidence score can be added (arrow 161) as an indicator or flag or meta-data that associated with the original email message that is stored in (or is accessible via) in the Email Server 110. Additionally or alternatively, for example, if the weighted phishing confidence score is greater than a pre-defined threshold value, or is within a pre-defined range-of-values, or meets other conditions or criteria, then a separate or stand-alone alert message may be sent to a system administrator of the Protected Entity and/or to the intended recipient of the email message.

In some embodiments, the Phishing Detection ML Model 116 can be trained and provided in advance; for example, it may be generated manually, and/or by using supervised ML or reinforcement learning (RL), and/or by utilizing the LLM 108 itself for constructing such model. For example, the LLM 108 may review and analyze (i) a first dataset having email messages that are known to be phishing attacks, and (ii) a second dataset having email messages that are known to be legitimate non-attack email messages; and the LLM may autonomously generate indicators for phishing attacks and/or optimal scores for phishing email detection confidence. Similar models may also be constructed with regard to other types of email messages or communications or contents; for example, to classify or to detect spam/junk emails, or emails (or incoming communications) from dissatisfied/angry customers, or emails (or incoming communications) from customers that indicate or that hint that they consider to leave the Protected Entity or to switch to another provider, or the like.

In some embodiments, instead of performing the steps indicated by arrows 158 and onward, an alternative approach may utilize the LLM 108 itself for phishing attack detection; for example, by constructing and/or training a customized or tailored LLM for this specific evaluation purpose, based on annotated/pre-labeled training set of phishing emails and non-phishing emails. Then Email Security Agent 112, instead of sending to LLM 108 the query envelope having the set of questions, can submit to LLM 108 a modified query envelope having (i) the content of the email message, and (ii) meta-data of the email message, and (iii) a command or a prompt to respond “Is this message likely to be a phishing attack message, and what is the confidence level of your answer?”. In some embodiments, this approach may be easier to implement, but may be more expensive operationally, due to higher costs of training and/or hosting and/or querying a custom LLM.

In some embodiments, a third approach may be used: firstly, the Email Security Agent 112 queries the LLM with regard to the particular answers to the particular questions for the specific email message; secondly, the LLM-based responses are used as feature indicators, and the Email Security Agent 112 determines a weighted confidence score (WCS) for phishing attack detection (or for other malicious activity/content), generated by or at the Email Security Agent 112 itself or by an associated or included or co-located unit such as a WCS Generator 125. Thirdly, the Email Security Agent 112 selects an operation based on the value of WSC. For example, the WSC may be in a range of 0 to 100, whereas 0 indicates full confidence that the email message is legitimate, and 100 indicates full confidence that the email message is a phishing attack. The Email Security Agent 112 may be configured in advance as follows: (a) if the WSC value is greater than 75, then proceed to flag this email message as a phishing attack; (b) if the WSC value is smaller than 20, then proceed to flag this email message as legitimate; (c) otherwise, namely if the WSC is in the range of 20 to 75 (including these two values), then: the Email Security Agent 112 submits the email message (and its meta-data) to a particular LLM that was trained specifically for classification of messages as being phishing messages or non-phishing messages, to obtain an LLM-based evaluation from that specifically-trained LLM with regard to the general query of “is this email message a phishing attack?”. In some embodiments, a first LLM may be specifically trained and used to respond to the specific questions that are included in a Query Envelope; and a second, different, LLM may be specifically trained and used to respond to the general query of “is this email message a phishing attack”, if such general query is reached.

In accordance with some embodiment, in addition to generating indicators and flags or alert messages, the Email Security Agent 112 may further perform one or more pre-defined or dynamically-selected risk mitigation operations or fraud mitigation operations; for example, discarding or deleting the email message, quarantining it or moving it into a particular vault or folder or account, creating one or more flags, adding a “warning” header inside the email body and/or the email subject line, forwarding or copying the email message to a particular inbox or recipient or fraud investigator or to law enforcement, or the like. In some embodiments, the Email Security Agent 112 may be configured to select one or more operations based on the weighted confidence score that was determined for the email message; such that a high WSC value may trigger a message quarantine, a medium WSC value may trigger an adding of a “warning” header, or the like. In some embodiments, the particular operation or set-of-operations are selected by a Risk/Fraud Mitigation Unit 119, which may be associated with the Email Security Agent 112 and/or with the Email Server 110, or may be part of (or co-located with) the Email Security Agent 112 or the Email Server 110.

In some embodiments, as an integral part of the collection and construction of OC, and/or as a preceding step that is performed before utilization of the already-constructed OC, the system may take into account (or, may perform initial filtering based on) a determined relationship or connection between: (I) the sender of the message, and/or one or more entities that are estimated or known to be associated with the sender of the message, and (II) the recipient (or multiple recipients) of the message, and/or one or more entities that are estimated or known to be associated with the recipient(s) of the message; and such insights may be generated and utilized as a user-oriented/user-based OC, or as a “user context” aspect of the OC or that accompanies the OC. In a first example, the system may check whether there have been previous communications between the current sender and the current recipient, via the same communication platform (e.g., the incoming message is an email message, and the system checks whether there had been previous email correspondence between this sender and this recipient) and/or via other communication platforms (e.g., the incoming message is an email message, and the system checks whether there had been previous and/or parallel IM correspondence between this sender and this recipient). The system may further check and determine, and utilize data about, how many such previous iterations of previous communications has existed between these parties, and who initiated those previous communications, and what were the timing and/or frequency and/or length (in words, in bytes) of such previous communications, and/or whether such previous communications were related to the topic of the current message being evaluated, and/or may take into account other characteristics of such other previous communications between the sender and the recipient. In some embodiments, the system may utilize a set of rules for determining an initial risk score for the evaluated message based on such characteristics; and/or for increasing or decreasing a risk score that is in the process of being determined for the evaluated message.

For example, a first rule may define that the existence of N previous communications by email and/or M previous communications by IM, in the past T days, between the sender and the recipient of the message being evaluated, may reduce the risk score or may even nullify it. In another example, the existence of previous communications between the sender of the evaluated message, and one or more other team-members at the Protected Entity that are not the recipient of the evaluated message, may also be utilized and may reduce the risk score for the evaluated message. In yet another example, the fact that the recipient of the evaluated message had previously sent, to the sender of the evaluated message, at least N email messages in the past T days, and/or has written at least L words in each such message, and/or has attached at least F files across those N previous messages, may also be utilized and may reduce the risk score for the evaluated message. In still another example, when the domain name portion of the email address of the sender of the evaluated message is not a generic/general email suffix (e.g., “Gmail.com” or “Yahoo.com”), but rather is a non-generic/non-general/organizational/unique domain name or email suffix (e.g., “IBM.com” or “Tesla.com”), then the system may take into account the existence, the number, the timing, the frequency, the length, and/or other characteristics of previous correspondence between (I) other entities from the same domain name of the sender, and (II) the recipient of the evaluated message and/or other entities at the Protected Entity.

In some embodiments, optionally, a Domain Reputation Unit (which may be functionally associated with the Email Security Agent 112 and/or the Email Server 110) may provide data indicating the positive reputation or the negative reputation of a particular domain, or a particular sender; based on the email address and/or domain name and/or IP address and/or email nickname and/or email relay path and/or other meta-data of the email message or its header. The positive reputation (e.g., indicating that the sender is trustworthy or legitimate) or the negative reputation (e.g., indicating that the sender is known to be a sender of “spam” or “junk” messages or fraudulent messages or phishing messages or disinformation) may be used by the Email Security Agent 112, for initial filtering-out or initial quarantining of evaluated emails; optionally avoiding the need to use ML classification and/or LLM-based analysis on such email message. In some embodiments, if and only if an initial evaluation, that is based on (or that takes into account) such reputation data of the sender and/or of other parameters of the email message (e.g., relay path; relay nodes; IP addresses) indicates that the message is not malicious on its face, the system proceeds to perform the ML classification and/or the LLM-based analysis. In some embodiments, such reputation data is not necessarily utilized, or is not exclusively utilized, for an initial filtering-out stage; rather, such reputation data or user context data may further be incorporated into the OC data that is generated by the system, and/or may otherwise augment such OC data for evaluating the legitimacy or maliciousness of a particular message.

In some embodiments, optionally, positive (or negative) reputation, or other data about user context, may be extended by the system from a first particular entity (e.g., sender) to a second particular entity (e.g., another sender), based on an implied/deduced/determined/known association between the two entities. For example, the system evaluates an email message that was sent from “Sarah@Company234.com” to a recipient “Adam@Protected-Entity.com”; the system may estimate that another sender, “Jack@Company234.com”, is legitimate, based on finding dozens of previous emails that were exchanged between that sender (Jack) and the recipient of the currently-evaluated message (Adam) in the past 30 days; the system may extend the positive reputation of the known sender “Jack@Company234.com” to the new sender “Sarah@Company234.com”, based on their sharing of the same domain, and/or based on other pre-defined indicators. For example, the system may detect that in the past, the sender of the currently-evaluated message has appeared as a CC recipient on some messages that were exchanged between the legitimate party (Jack) and the present recipient (Adam), and this may imply that the current sender (Sarah) is also legitimate, or this may reduce a risk score that is associated with the currently-evaluated message from Sarah to Adam. The above was only a non-limiting example; other suitable rules may be defined and utilized.

In some embodiments, the utilization of LLM 108 may be expensive, computationally and/or financially, or may require an increased set of resources (e.g., processing resources, memory resources, time); and therefore, the utilization of LLM 108 may be invoked or triggered if (and only if) or after (and only after) an initial detection process was performed and/or was not successful and/or has failed and/or has yielded results that are below a pre-defined confidence level. For example, in a first set of embodiments, an initial attempt is performed to detect a malicious/phishing message based on deterministic rules, e.g., dictionary-based rules; textual comparison the textual strings from known phishing/malicious messages; detection of a sender or an email relay node that are known to dissipate spam/malicious/phishing emails; if that initial stage has determined or estimated, beyond a pre-defined level of confidence, that the message is malicious, then this may suffice for the Email Security Agent 112, and LLM-based processing may be skipped; otherwise, the LLM-based processing of that email message is performed. In a second set of embodiments, an initial attempt is performed to detect a malicious/phishing message based on deterministic rules; if that initial stage has determined or estimated, beyond a pre-defined level of confidence, that the message is malicious, then this may suffice for the Email Security Agent 112, then ML classification of the message without using LLM-based processing can be performed; and only if the ML classification of the message without the LLM-based processing did not reach a pre-defined confidence level, the LLM-based processing of that email message is performed. In a third set of embodiments, for example, a deterministic/rule-based detection process is firstly performed on the incoming message; if that initial detection process concludes that the message is legitimate/non-malicious, then the system still proceeds to perform at least an ML classification of the message, and then the message continues to utilize also LLM-based processing if the ML classification result was below a pre-defined confidence level. Other chaining conditions or chaining rules may be defined and used for staggered or conditioned or selective activation or selective invocation of the LLM-based processing.

The Email Security Agent 112 further performs logging and monitoring (arrow 162), using a Logging and Monitoring Unit 117, of each LLM-based query/response/evaluation, as well as of the WSC determined for each email message and the particular LLM-based responses and their confidence scores; thereby enabling to implement a feedback loop for monitoring and improving the accuracy of detection. For example, drifts from accurate classifications can be used to fine-tune the system/the ML model/the LLM, and/or to temporarily disable blocking or quarantining of emails to prevents “false positive” errors.

In a demonstrative example, an end-user team-member of the Protected Entity utilizes an electronic device (e.g., desktop computer, laptop computer, smartphone, tablet, smart-watch) equipped with an Email Reader 121 application or module, to read or access incoming email messages (arrow 163). The end-user receives a notification from the Email Security Agent 112 and/or from the Email Server 110 with regard to messages that were quarantined, and may be provided with a mechanism to review or release such messages. The end-user further sees the relevant indicators or warnings or flags that were generated for emails that were not deleted/not quarantined. The end-user may provide feedback via a feedback loop or feedback mechanism (arrow 164), by indicating his feedback back to the Email Security Agent 112 (directly, or via the Email Server 110); with feedback such as, “yes, this email message that was flagged/quarantined as malicious is indeed malicious”, or conversely “no, this email message was incorrectly flagged/quarantined as malicious but is actually legitimate”; and in some embodiments may provide a third feedback of “I am not sure whether or not the classification as malicious is correct”. The user's feedback may be utilized by the system to fine-tune or re-train the ML units/LLM units involved in the evaluation process, to modify weights assigned to particular features or parameters or indicators, to construct or to update a white-list or a black-list of senders, or for other fine-tuning operations. In some embodiments, and particularly if a Query Envelope was utilized with a set of particular questions, the end-user may be provided with a copy of the particular questions that were posed by the Email Security Agent 112 to the LLM 108 with regard to the specific email message, and with the LLM-based responses (and optionally also the confidence score for each LLM-based response); and the end-user may provide feedback with regard to the accuracy of each of those responses. Optionally, a chat-like or chat-based feedback loop may be used; for example, the end-user may indicate that the LLM-based response to Question 3 appears to be incorrect; the Email Security Agent 112 may then request from the LLM 108 to provide the particular support for the LLM-based response for Question 3; the LLM 108 may provide the particular support (e.g., by selectively highlighting or copying the email-portions that had supported the response), which is then displayed or conveyed to the end-user; who in turn can provide further feedback, such as, indicating that the LLM-based response to Question 3 was indeed correct, or conversely indicating or insisting that the LLM-based response to Question 3 is incorrect. Accordingly, some embodiments may provide explanation(s) for each phishing indicator that was detected, and may collect a per-indicator feedback from the end-user; and such feedbacks may then be utilized to improve or fine-tune the system's performance and accuracy, or to periodically re-calculate the entire model that is utilized by the LLM unit or the ML unit or other modules. In some embodiments, user-provided feedback to previous classification(s) of email messages, can be utilized as an additional feature in training or calculating a revised model.

It is noted that in the field of cyber-security, it is virtually impossible to obtain 100 percent accuracy and efficiency in all automated decisions; and still, embodiments of the present invention can certainly provide utility and benefits to organizations by blocking or capturing or filtering or quarantining malicious email messages or fraudulent communications (or, in some embodiments, by classifying incoming communications as spam/junk, or as reflecting customer anger or customer dissatisfaction); and such utility may be provided by some embodiments even if the system does not operate with 100 percent accuracy. In a first example, some embodiments may be configured to correctly block at least 95 percent of incoming email messages, and this is still beneficial even if 5 percent of malicious incoming emails are missed as “false negative” error by the system and manage to go through without a warning. In a second example, some embodiments may be configured to correctly classify 99 percent of legitimate incoming emails as indeed legitimate and non-malicious, and this is still beneficial even if 1 percent of the incoming emails suffer from a “false positive” error. In accordance with some embodiments, weights of parameters or features may be modified or tweaked or fine-tuned, and/or the number of type of particular questions that are selected from the pool and are posed to the LLM 108 may be modified or tweaked, and/or threshold values for WCS evaluation may be set or modified, to ensure that the rate of “false negative” errors remains below N percent and/or to ensure that the rate of “false positive” errors remains below P percent, wherein N and P are numbers in the range of 0 to 100 as configured by an administrator of the system.

Some embodiments provide a computerized method comprising: automatically evaluating whether a digital message received at a Protected Entity is malicious or legitimate, by performing: (a) obtaining extracted data from documents and data repositories of said Protected Entity; feeding the extracted data into a Large Language Model (LLM) engine; and constructing an Organizational Context Index having vectors of LLM-generated embeddings that describe relations and roles of members and objects of the Protected Entity; (b) prompting said LLM to evaluate whether said digital message is malicious or legitimate, based on LLM analysis of a query envelope that includes at least: (i) content of the digital message, and (ii) meta-data of the digital message, and (iii) a set of LLM-based embeddings from the Organizational Context Index that pertain to said digital message.

In some embodiments, step (b) comprises: (b1) automatically selecting, from a pool of pre-defined questions, a set of probing questions that are determined to be relevant to said digital message; wherein each probing question relates to a particular aspect of the digital message;

(b2) adding said set of probing questions to the query envelope that is submitted to the LLM engine.

In some embodiments, step (b) further comprises: (b3) receiving from the LLM engine a set of responses; wherein each response corresponds to one of the probing questions; wherein each response is accompanied by a confidence level indicator.

In some embodiments, step (b) further comprises: (b4) utilizing the responses and confidence level indicators that were received from the LLM engine in step (b3), as weighted parameters of a Machine Language (ML) model that classifies said digital message as either malicious or legitimate.

In some embodiments, step (b) further comprises: (b5) based on said ML model, constructing a Weighted Confidence Score indicating a likelihood that said incoming message is malicious.

In some embodiments, step (b) further comprises: (b6) if said Weighted Confidence Score is within a particular range-of-values, then: selecting and performing, with regard to said digital message, one or more fraud mitigation operations from a pool of fraud mitigation operations.

In some embodiments, the pool of fraud mitigation operations comprises at least: (i) quarantining the digital message, (ii) flagging the digital message as possibly malicious.

In some embodiments, the method further comprises: receiving user feedback, indicating whether or not LLM-based evaluation of the digital message as malicious or legitimate is correct; in response to said user feedback, performing at least one of: (i) re-training the LLM engine with said user feedback; (ii) modifying parameter weights that are assigned by said ML model.

In some embodiments, the method comprises: (A) generating data indicating user-specific context, based on at least one of: email address of a sender of the digital message, Internet Protocol (IP) address of the sender of the digital message, relay path of the digital message, meta-data of the digital message, domain name portion of the email address of the digital message, reputation data about an entity that is associated with the sender of the digital message; (B) prior to invoking LLM-based processing of said digital message, performing an initial stage of malicious message detection based on said data indicating user-specific context; (C) if and only if said initial stage of step (B), does not indicate that the digital message is malicious with an associated level of confidence that is greater than a pre-defined threshold value, then: performing Machine Learning (ML) classification of said digital message as either malicious or legitimate, and performing LLM-based analysis of said digital message towards determining whether said digital message is either malicious or legitimate.

In some embodiments, step (a) comprises: extracting data at least from an Active Directory (AD) unit of said Protected Entity, and using data extracted from said AD unit to construct said Organizational Context Index.

In some embodiments, step (a) comprises: extracting data at least from a computerized management system of said Protected Entity, wherein the computerized management system comprises at least one of: a Customer Relationship Management (CRM) system, a Supply Chain Management (SCM) system, an Enterprise Resource Planning (ERP) system; and using data, that was extracted from said computerized management system of said Protected Entity, to construct said Organizational Context Index.

In some embodiments, the method further comprises: specifically training said LLM engine to distinguish between (i) an email message that is part of a phishing attack, and (ii) an email message that is not part of a phishing attack, by using at least (i) a first dataset having only email messages that are known to be part of phishing attacks, and (ii) a second, different, dataset having only email messages that are known to not be part of phishing attacks.

In some embodiments, the method further comprises: (c1) prompting said LLM engine to generate an LLM-based output indicating whether or not said digital message is malicious and an associated level of confidence, based on LLM analysis of: (i) said digital message, and (ii) meta-data of said digital message, and (iii) said set of LLM-based embeddings from the Organizational Context Index that pertain to said digital message. In some embodiments, step (c1) is performed if, and only if, the operations of steps (a) and (b) did not indicate, above a pre-defined level of confidence, whether said digital message is malicious or legitimated.

In some embodiments, said probing questions include at least: a first probing question, submitted to the LLM engine, inquiring whether a sender of the digital message is a known entity from the Organizational Context Index; a second probing question, submitted to the LLM engine, inquiring whether a recipient of the digital message is a known entity from the Organizational Context Index.

In some embodiments, said probing questions include at least: a probing question, submitted to the LLM engine, inquiring whether or not a topic to which the digital message pertains, matches an organizational role of the recipient of the digital message.

17. The computerized method of claim 2, said probing questions include at least: a probing question, submitted to the LLM engine, inquiring whether or not a topic to which the digital message pertains, matches a role towards the Protected Entity of the sender of the digital message.

In some embodiments, said probing questions include at least: a probing question, submitted to the LLM engine, that pertains directly to at least one of: a domain name associated with a sender of the digital message, a domain name associated with a recipient of the digital message, an Internet Protocol (IP) address associated with a sender of the digital message, data about a relay node that relayed the digital message from the sender to the recipient.

Some embodiments provide a non-transitory storage medium having stored thereon instructions that, when executed by a machine, cause the machine to perform a method as described above and/or herein.

Some embodiments provide a system comprising: one or more hardware processors, configured to execute code; associated with one or more memory units, configured to store data; wherein the one or more hardware processors are configured to perform an automated process or an automated method as described above and/or herein.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be implemented by using hardware units, software units, processors, CPUs, DSPs, integrated circuits, memory units, storage units, wireless communication modems or transmitters or receivers or transceivers, cellular transceivers, a power source, input units, output units, Operating System (OS), drivers, applications, and/or other suitable components.

Some embodiments may be implemented by using a special-purpose machine or a specific-purpose that is not a generic computer, or by using a non-generic computer or a non-general computer or machine. Such system or device may utilize or may comprise one or more units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented by using code or program code or machine-readable instructions or machine-readable code, which is stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such device to perform a method in accordance with the present invention.

Some embodiments may be utilized with a variety of devices or systems having a touch-screen or a touch-sensitive surface; for example, a smartphone, a cellular phone, a mobile phone, a smart-watch, a tablet, a handheld device, a portable electronic device, a portable gaming device, a portable audio/video player, an Augmented Reality (AR) device or headset or gear, a Virtual Reality (VR) device or headset or gear, a “kiosk” type device, a vending machine, an Automatic Teller Machine (ATM), a laptop computer, a desktop computer, a vehicular computer, a vehicular dashboard, a vehicular touch-screen, or the like.

The system(s) and/or device(s) of some embodiments may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of some embodiments may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with some embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit, a Flash drive), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, MATLAB, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results (e.g., within a pre-defined threshold level of similarity; such as, within 5 percent above or below a pre-defined threshold value), among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some embodiments have been illustrated and described herein, many modifications, substitutions, changes, and equivalents may occur to those skilled in the art. Accordingly, the claims are intended to cover all such modifications, substitutions, changes, and equivalents.

What is claimed is:

1. A computerized method comprising:
automatically evaluating whether a digital message received at a Protected Entity is malicious or legitimate, by performing:
(a) obtaining extracted data from documents and data repositories of said Protected Entity;
feeding the extracted data into a Large Language Model (LLM) engine;
and constructing an Organizational Context Index having vectors of LLM-generated embeddings that describe relations and roles of members and objects of the Protected Entity;
(b) prompting said LLM to evaluate whether said digital message is malicious or legitimate, based on LLM analysis of a query envelope that includes at least: (i) content of the digital message, and (ii) meta-data of the digital message, and (iii) a set of LLM-based embeddings from the Organizational Context Index that pertain to said digital message.

2. The computerized method of claim 1,
wherein step (b) comprises:
(b1) automatically selecting, from a pool of pre-defined questions, a set of probing questions that are determined to be relevant to said digital message;
wherein each probing question relates to a particular aspect of the digital message;
(b2) adding said set of probing questions to the query envelope that is submitted to the LLM engine.

3. The computerized method of claim 2,
wherein step (b) further comprises:
(b3) receiving from the LLM engine a set of responses,
wherein each response corresponds to one of the probing questions,
wherein each response is accompanied by a confidence level indicator.

4. The computerized method of claim 3,
wherein step (b) further comprises:
(b4) utilizing the responses and confidence level indicators that were received from the LLM engine in step (b3), as weighted parameters of a Machine Language (ML) model that classifies said digital message as either malicious or legitimate.

5. The computerized method of claim 4,
wherein step (b) further comprises:
(b5) based on said ML model, constructing a Weighted Confidence Score indicating a likelihood that said incoming message is malicious.

6. The computerized method of claim 5,
wherein step (b) further comprises:
(b6) if said Weighted Confidence Score is within a particular range-of-values, then:
selecting and performing, with regard to said digital message, one or more fraud mitigation operations from a pool of fraud mitigation operations.

7. The computerized method of claim 6,
wherein the pool of fraud mitigation operations comprises at least: (i) quarantining the digital message, (ii) flagging the digital message as possibly malicious.

8. The computerized method of claim 7, further comprising:
receiving user feedback, indicating whether or not LLM-based evaluation of the digital message as malicious or legitimate is correct;
in response to said user feedback, performing at least one of:
(i) re-training the LLM engine with said user feedback;
(ii) modifying parameter weights that are assigned by said ML model.

9. The computerized method of claim 1, comprising:
(A) generating data indicating user-specific context, based on at least one of: email address of a sender of the digital message, Internet Protocol (IP) address of the sender of the digital message, relay path of the digital message, meta-data of the digital message, domain name portion of the email address of the digital message, reputation data about an entity that is associated with the sender of the digital message;
(B) prior to invoking LLM-based processing of said digital message, performing an initial stage of malicious message detection based on said data indicating user-specific context;
(C) if and only if said initial stage of step (B), does not indicate that the digital message is malicious with an associated level of confidence that is greater than a pre-defined threshold value, then: performing Machine Learning (ML) classification of said digital message as either malicious or legitimate, and performing LLM-based analysis of said digital message towards determining whether said digital message is either malicious or legitimate.

10. The computerized method of claim 1,
wherein step (a) comprises:
extracting data at least from an Active Directory (AD) unit of said Protected Entity,
and using data extracted from said AD unit to construct said Organizational Context Index.

11. The computerized method of claim 1,
wherein step (a) comprises:
extracting data at least from a computerized management system of said Protected Entity,
wherein the computerized management system comprises at least one of:
a Customer Relationship Management (CRM) system,
a Supply Chain Management (SCM) system,
an Enterprise Resource Planning (ERP) system;
and using data, that was extracted from said computerized management system of said Protected Entity, to construct said Organizational Context Index.

12. The computerized method of claim 1,
further comprising:
specifically training said LLM engine to distinguish between (i) an email message that is part of a phishing attack, and (ii) an email message that is not part of a phishing attack,
by using at least (i) a first dataset having only email messages that are known to be part of phishing attacks, and (ii) a second, different, dataset having only email messages that are known to not be part of phishing attacks.

13. The computerized method of claim 1, further comprising:
(c1) prompting said LLM engine to generate an LLM-based output indicating whether or not said digital message is malicious and an associated level of confidence,
based on LLM analysis of: (i) said digital message, and (ii) meta-data of said digital message, and (iii) said set of LLM-based embeddings from the Organizational Context Index that pertain to said digital message.

14. The computerized method of claim 1,
wherein step (c1) is performed if, and only if, the operations of steps (a) and (b) did not indicate, above a pre-defined level of confidence, whether said digital message is malicious or legitimated.

15. The computerized method of claim 2,
wherein said probing questions include at least:
a first probing question, submitted to the LLM engine, inquiring whether a sender of the digital message is a known entity from the Organizational Context Index;
a second probing question, submitted to the LLM engine, inquiring whether a recipient of the digital message is a known entity from the Organizational Context Index.

16. The computerized method of claim 2,
wherein said probing questions include at least:
a probing question, submitted to the LLM engine, inquiring whether or not a topic to which the digital message pertains, matches an organizational role of the recipient of the digital message.

17. The computerized method of claim 2,
wherein said probing questions include at least:
a probing question, submitted to the LLM engine, inquiring whether or not a topic to which the digital message pertains, matches a role towards the Protected Entity of the sender of the digital message.

18. The computerized method of claim 2,
wherein said probing questions include at least:
a probing question, submitted to the LLM engine, that pertains directly to at least one of:
a domain name associated with a sender of the digital message,
a domain name associated with a recipient of the digital message,
an Internet Protocol (IP) address associated with a sender of the digital message,
data about a relay node that relayed the digital message from the sender to the recipient.

19. A non-transitory storage medium having stored thereon instructions that, when executed by a machine, cause the machine to perform a method comprising:
automatically evaluating whether a digital message received at a Protected Entity is malicious or legitimate, by performing:
(a) obtaining extracted data from documents and data repositories of said Protected Entity;
feeding the extracted data into a Large Language Model (LLM) engine;
and constructing an Organizational Context Index having vectors of LLM-generated embeddings that describe relations and roles of members and objects of the Protected Entity;
(b) prompting said LLM to evaluate whether said digital message is malicious or legitimate, based on LLM analysis of a query envelope that includes at least: (i) content of the digital message, and (ii) meta-data of the digital message, and (iii) a set of LLM-based embeddings from the Organizational Context Index that pertain to said digital message.

20. A system comprising:
one or more hardware processors, configured to execute code;
associated with one or more memory units, configured to store data;
wherein the one or more hardware processors are configured to perform an automated process comprising:
automatically evaluating whether a digital message received at a Protected Entity is malicious or legitimate, by performing:
(a) obtaining extracted data from documents and data repositories of said Protected Entity;
feeding the extracted data into a Large Language Model (LLM) engine;
and constructing an Organizational Context Index having vectors of LLM-generated embeddings that describe relations and roles of members and objects of the Protected Entity;
(b) prompting said LLM to evaluate whether said digital message is malicious or legitimate, based on LLM analysis of a query envelope that includes at least: (i) content of the digital message, and (ii) meta-data of the digital message, and (iii) a set of LLM-based embeddings from the Organizational Context Index that pertain to said digital message.
